(19) United States
(12) Patent Application Publication
(10) Pub. No.: US 2023/0289224 A1
(43) Pub. Date: Sep. 14, 2023

(54) Reducing Lock Usage for Managing Nodes in a Distributed System

(71) Applicant: Dell Products L.P., Round Rock, TX (US)

(72) Inventor: Attilio Rao, Roma (IT)

(21) Appl. No.: 17/581,191

(22) Filed: Jan. 21, 2022

(51) Int. Cl. G06F 9/50

(52) U.S. Cl. CPC G06F 9/50

(57) ABSTRACT

A system can store identifiers of devices of a computing cluster in a hash table, wherein worker threads of the computing cluster access the hash table to identify respective devices from which to fetch work. The system can maintain an insertion index for the hash table that identifies a first bucket of the hash table into which a first next device identifier is to be inserted. The system can maintain a fetch index for the hash table that identifies a second bucket of the hash table into which a second next device identifier is to be removed. The system can, in response to determining to identify a first device identifier of the identifiers of devices to a first worker thread of the worker threads, atomically accessing the first device identifier at the fetch index of the hash table and incrementing the value of the fetch index, and associating the first worker thread with the first device identifier.

### BACKGROUND

A distributed computing system can comprise multiple computing nodes. Work tasks generated by one computing node of the multiple computing nodes can be processed by another node of the multiple computing nodes.

### SUMMARY

The following presents a simplified summary of the disclosed subject matter in order to provide a basic understanding of some of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

An example system can operate as follows. The system can store identifiers of devices of a computing cluster in a hash table, wherein worker threads of the computing cluster access the hash table to identify respective devices from which to fetch work. The system can maintain an insertion index for the hash table that identifies a first bucket of the hash table into which a first next device identifier is to be inserted. The system can maintain a fetch index for the hash table that identifies a second bucket of the hash table into which a second next device identifier is to be removed. The system can, in response to determining to identify a first device identifier of the identifiers of devices to a first worker thread of the worker threads, atomically accessing the first device identifier at the fetch index of the hash table and incrementing the value of the fetch index, and associating the first worker thread with the first device identifier.

An example method can comprise storing, by a system comprising a processor, identifiers of objects in a hash table. The method can further comprise maintaining, by the system, an insertion index for the hash table that identifies a first bucket of the hash table into which a first next object identifier is to be inserted. The method can further comprise maintaining, by the system, a fetch index for the hash table that identifies a second bucket of the hash table into which a second next object identifier is to be removed. The method can further comprise, in response to determining to communicate, to a requestor, a first object identifier of the identifiers of objects, communicating, by the system to the requestor, the first object identifier that is stored at the fetch index of the hash table, and incrementing a value of the fetch index.

An example non-transitory computer-readable medium can comprise instructions that, in response to execution, cause a system comprising a processor to perform operations. These operations can comprise storing identifiers of objects in a hash table. These operations can further comprise maintaining a first index for the hash table that identifies a first slot of the hash table into which a first next object identifier is inserted. These operations can further comprise maintaining a second index for the hash table that identifies a second slot of the hash table into which a second next object identifier is removed. These operations can further comprise, in response to determining to provide a requestor with a first object identifier of the identifiers of objects, providing the requestor with the first object identifier that is stored at the second index of the hash table, and incrementing a value of the second index.

### BRIEF DESCRIPTION OF THE DRAWINGS

Numerous embodiments, objects, and advantages of the present embodiments will be apparent upon consideration of the following detailed description, taken in conjunction with the accompanying drawings, in which like reference characters refer to like parts throughout, and in which:

FIG. 1 illustrates an example system architecture that can facilitate reducing lock usage for managing nodes in a distributed system, in accordance with an embodiment of this disclosure;

FIG. 2 illustrates an example system architecture of a hash table that can facilitate reducing lock usage for managing nodes in a distributed system, in accordance with an embodiment of this disclosure;

FIG. 3 illustrates another example system architecture of a hash table that can facilitate reducing lock usage for managing nodes in a distributed system, in accordance with an embodiment of this disclosure;

FIG. 4 illustrates an example system architecture for inserting an object into a hash table that can facilitate reducing lock usage for managing nodes in a distributed system, in accordance with an embodiment of this disclosure;

FIG. 5 illustrates an example system architecture for fetching an object from a hash table that can facilitate reducing lock usage for managing nodes in a distributed system, in accordance with an embodiment of this disclosure;

FIG. 6 illustrates an example system architecture for circularly navigating a hash table that can facilitate reducing lock usage for managing nodes in a distributed system, in accordance with an embodiment of this disclosure;

FIG. 7 illustrates an example system architecture for locking individual buckets of a hash table that can facilitate reducing lock usage for managing nodes in a distributed system, in accordance with an embodiment of this disclosure;

FIG. 8 illustrates an example process flow that can facilitate reducing lock usage for managing nodes in a distributed system, in accordance with an embodiment of this disclosure;

FIG. 9 illustrates another example process flow that can facilitate reducing lock usage for managing nodes in a distributed system, in accordance with an embodiment of this disclosure;

FIG. 10 illustrates another example process flow that can facilitate reducing lock usage for managing nodes in a distributed system, in accordance with an embodiment of this disclosure;

FIG. 11 illustrates an example block diagram of a computer operable to execute an embodiment of this disclosure.

### DETAILED DESCRIPTION

### Overview

A computing cluster can comprise a group of computing nodes that work together to carry out tasks, such as storing data or processing tasks. A computing cluster can comprise a backend subsystem that manages communication among nodes in a cluster. The backend subsystem can comprise worker threads that scan a list of available devices (which are interconnected by the cluster) from which to fetch tasks to work on. When there is no work available by the devices, the worker threads can be put to sleep (and identified as sleeping in a list), from which a worker thread can be resumed when there is work available.

As used herein, the term “device” can generally encompass the term “node.” Nodes can generally be interconnected within a topology, so that they can communicate directly (that is, without cops). From the perspective of a single node, a device can be another node that is directly connected. A device can be described through its network properties. A component for reducing lock usage for managing nodes in a distributed system can generally view these entities as devices.

In some examples, a device management list can be maintained, which identifies devices that have work for worker threads to perform. Worker threads can access a device management list in a first-in-first-out (FIFO) approach, where a device identifier that was added to the device management list the earliest among device identifiers in the device management list is provided to a worker thread. This approach can be taken to exploit locality of device management accesses.

A FIFO device management list (or queue) can be implemented where a number of worker threads is fixed, while a number of connections increases monotonically with a number of nodes available in a cluster, and where the number of nodes available can increase beyond the number of worker threads.

In such examples, adding devices to a device management list, and fetching devices from a device management list can become a high-frequency operation, where performance can be negatively impacted by an increasing number of worker threads.

Some prior approaches to device management lists utilize traditional locks (or mutexes) can be expensive in terms of processing resources, and negatively impact an ability to scale the number of nodes in a cluster, as well as negatively impact performance of the cluster.

The present techniques can be implemented to reduce a number of locks used with a device management list, to improve efficiency of FIFO management of the device management list.

In contrast to prior approaches, which can implement a lock on an entire device management list, the present techniques can be implemented to reduce a number and scope of locks (e.g., where a prior technique might involve locking an entire device management list, the present techniques can involve a portion of the device management list).

According to the present techniques, a FIFO device management list can be implemented with a hash table, where buckets of the hash table are synchronized singularly. The hash table can be configured to have a sufficiently large number of buckets such that resource contention for a single bucket is unlikely.

Within such a hash table, a FIFO mechanism can be implemented with two indices, which can move monotonically and independently of each other. One index can be used for insertions to the hash table, and another index can be used for fetches from the hash table.

In some examples, there can be system architectures that implement such a hash table such that negative effects of race conditions are mitigated (e.g., there can be a specific safety belt mechanism that provides for restarting operations when a meaningful change happens between a scan and a remove or insert). A race condition can generally comprise a situation where a shared resource is accessed by multiple entities, and the timing of these accesses changes such that the accesses are being performed in an unintended order. As used herein, a meaningful change can generally involve a scenario where there is an attempt to remove a device identifier from a hash table, but the hash table is empty. In such a situation, operations that led to attempting to remove the device identifier can be restarted and it can be considered whether the conditions leading to a conclusion that there was work to fetch are true.

In such system architectures, it can be that sleeping worker threads are awoken when devices are added to the device management list such that there is at least one worker thread available when inserting devices into the device management list. In some examples, a hard lock of the hash table can be utilized while waking worker threads. In some examples, a hard lock of an entire hash table can be implemented to ensure that there are no latency spikes so as to serve an incoming request quickly.

The present techniques can provide for avoiding an excess of worker thread wakeups, so reducing an amount of processing resources used, and avoiding a need to reacquire hard locks on a sleep path to perform counters management.

### Example Architectures

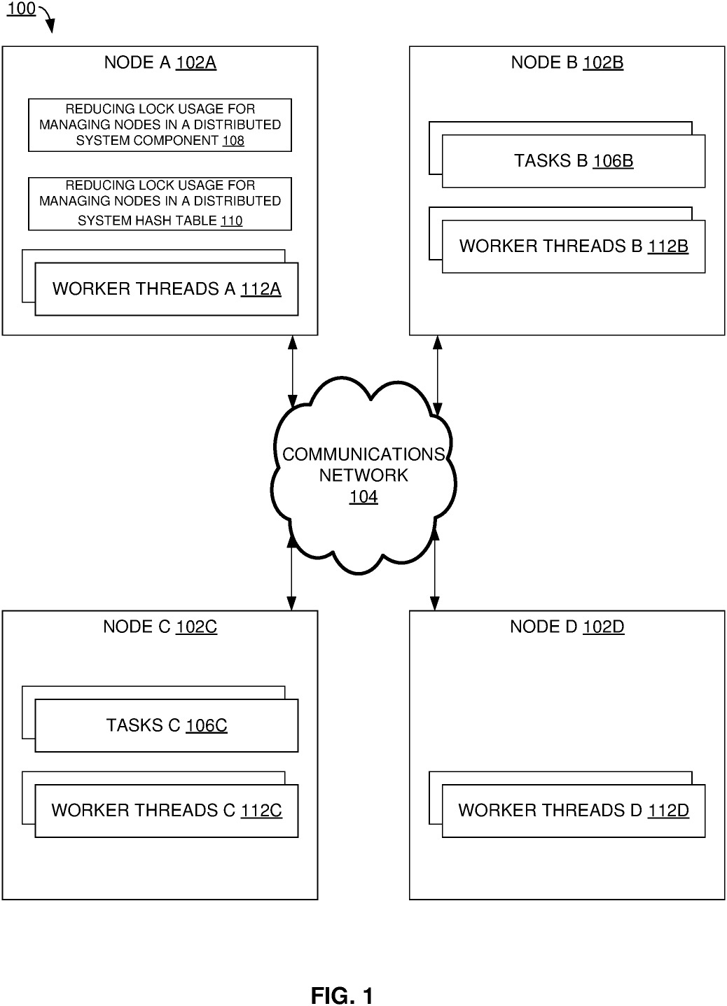

FIG. 1 illustrates an example system architecture 100 that can facilitate reducing lock usage for managing nodes in a distributed system, in accordance with an embodiment of this disclosure.

System architecture 100 comprises node A 102A, node B 102B, node C 102C, node D 102D, and communications network 104. In turn, node A 102A comprises reducing lock usage for managing nodes in a distributed system component 108, reducing lock usage for managing nodes in a distributed system hash table 110, and worker threads A 112A. Node B 102B comprises tasks B 106B and worker threads B 112B. Node C 102C comprises tasks C 106C and worker threads C 112C. Node D 102D comprises worker threads D 112D.

Node A 102A, node B 102B, node C 102C, node D 102D can form a computing cluster, which can generally comprise a collection of computers that work in concert and can logically be viewed as a single system. A computing cluster can sometimes be referred to as a distributed system.

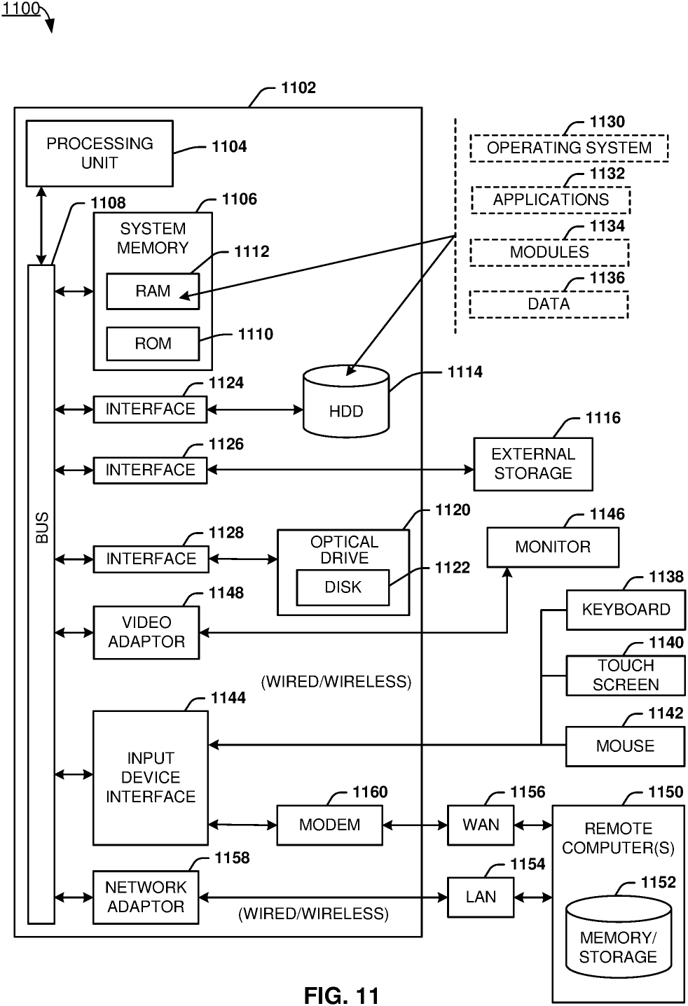

Each of node A 102A, node B 102B, node C 102C, node D 102D can be implemented with part(s) of computing environment 1100 of FIG. 11. Communications network 104 can comprise a computer communications network, such as the Internet.

Worker threads (e.g., worker threads A 112A) can comprise multiple worker threads that operate on their respective nodes. A thread can generally comprise a group of computer-executable instructions that can be scheduled by a computer scheduler to be run on a processor. A worker thread can contact reducing lock usage for managing nodes in a distributed system component 108 for an identifier of a node that has work to be performed. Reducing lock usage for managing nodes in a distributed system component 108 can access reducing lock usage for managing nodes in a distributed system hash table 110 to determine (or fetch) such a node (e.g., node B 102B, which has work to perform in the form of tasks B 106B) and return an identifier of that node to the worker thread. The worker thread can then access that node for a task to perform. When a worker thread is done performing the task, the worker thread can again communicate with reducing lock usage for managing nodes in a distributed system component 108 for another identifier of another node that has work to be performed.

Reducing lock usage for managing nodes in a distributed system hash table 110 can comprise a hash table which identifiers of devices with work to be perform can be maintained. A hash table can generally comprise a data structure that maintains multiple buckets in which data (e.g., identifiers of devices) can be stored, where an individual bucket can be accessed based on an index value. One bucket can store multiple identifiers of devices, in a FIFO queue, where a first identifier that was added to the bucket is the first identifier to be fetched from the bucket. Additionally, the hash table overall can be implemented with FIFO functionality with respect to device identifiers.

Where a node has work to perform, it can alert reducing lock usage for managing nodes in a distributed system component 108, which can insert an identifier of the node in reducing lock usage for managing nodes in a distributed system hash table 110. A device (as described and managed through its network properties) can be considered to be available for work upon verifying that the network device has incoming data available for consumption. This data can be stored and managed lucklessly in a driver ring buffer.

When a worker thread requests work, reducing lock usage for managing nodes in a distributed system component 108 can fetch a node identifier from reducing lock usage for managing nodes in a distributed system hash table 110, and remove the identifier from the hash table.

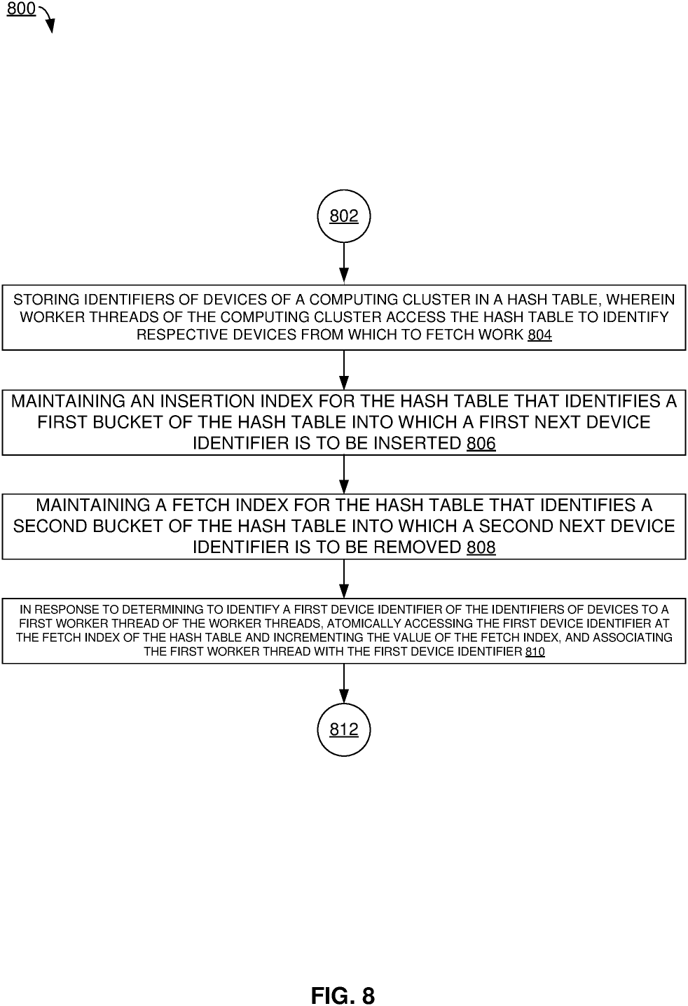

In some examples, reducing lock usage for managing nodes in a distributed system component 108 can implement part(s) of the process flows of FIGS. 8-10 to facilitate reducing lock usage for managing nodes in a distributed system.

It can be appreciated that system architecture 100 is one example system architecture for reducing lock usage for managing nodes in a distributed system, and that there can be other system architectures that facilitate reducing lock usage for managing nodes in a distributed system.

Furthermore, it can be appreciated that different nodes can host more or fewer worker threads, and have more or fewer tasks to perform than is depicted. In some examples, a node can host zero or more worker threads. And in some examples, and at various times, a node can have zero or more tasks to be performed.

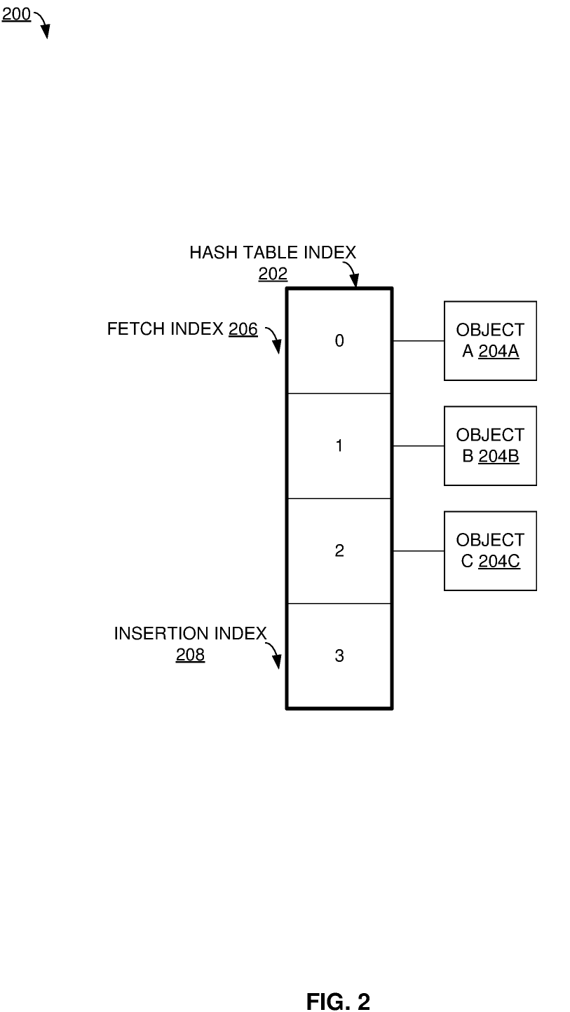

FIG. 2 illustrates an example system architecture 200 of a hash table that can facilitate reducing lock usage for managing nodes in a distributed system, in accordance with an embodiment of this disclosure. In some examples, system architecture 200 can be used to implement reducing lock usage for managing nodes in a distributed system hash table 110 of FIG. 1.

System architecture 200 comprises hash table index 202, fetch index 206, insertion index 208, and three objects stored in a hash table - object A 204A, object B 204B, and object C 204C.

Hash table index 202 can comprise an index to a hash table, by which buckets of the hash table can be addressed. Hash table index 202 has for elements - index 0, index 1, index 2, and index 3. Object A 204A, object B 204B, and object C 204C are stored, respectively, in index 0, index 1, and index 2. Each of object A 204A, object B 204B, and object C 204C can identify a node of system architecture 100 of FIG. 1 (e.g., node A 102A) that has a task to perform.

Fetch index 206 can indicate a next bucket from which a device identifier will be fetched. Here, fetch index 206 points at index 0 of hash table index 202, indicating that object A 204A is the next object to fetch.

Insertion index 208 can indicate a next bucket to which a device identifier will be inserted. Here, insertion index 208 points at index 3 of hash table index 202, indicating that index 3 addresses the bucket at which the next insertion will occur.

When a fetch or insertion is performed, fetch index 206 and insertion index 208 can be incremented, respectively.

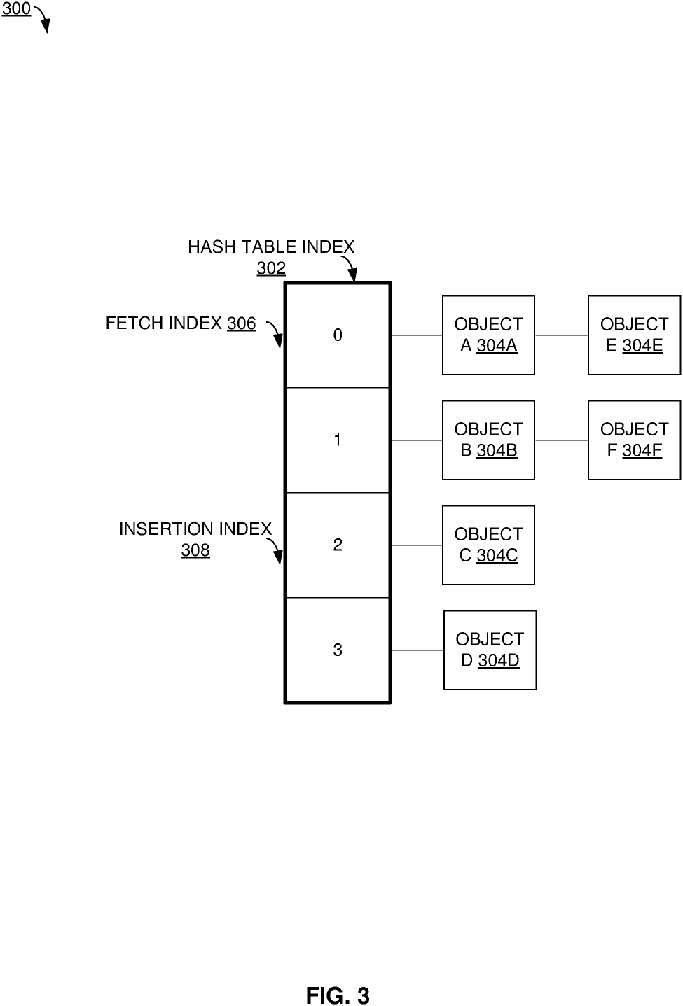

FIG. 3 illustrates another example system architecture 300 of a hash table that can facilitate reducing lock usage for managing nodes in a distributed system, in accordance with an embodiment of this disclosure. In some examples, system architecture 300 can be used to implement reducing lock usage for managing nodes in a distributed system hash table 110 of FIG. 1.

System architecture 300 can generally comprise system architecture 200 of FIG. 2 where multiple objects are stored in certain hash table buckets.

System architecture 300 comprises hash table index 302 (which can be similar to hash table index 202), fetch index 306 (which can be similar to fetch index 206), insertion index 308 (which can be similar to insertion index 208), and six objects stored in a hash table – object A 304A, object B 304B, and object C 304C (which can be similar to object A 204A, object B 204B, and object C 204C, respectively), as well as object D 304D, object E 304E, and object F 304F.

Relative to system architecture 200, three objects have been added — object D 304D, object E 304E, and object F 304F — and insertion index 308 has been similarly incremented.

It can be seen that a bucket can store multiple objects. For example, the bucket at index 0 stores object A 304A and object E 304E, and the bucket at index 1 stores object B 304B and object F 304F. Where a bucket stores multiple objects, a bucket can be treated as a FIFO queue. Insertions can be made to an end of a queue, and fetches can be made from the front of a queue. For example, in the case of system architecture 300 and index 0, object A 304A would be fetched before object E 304E.

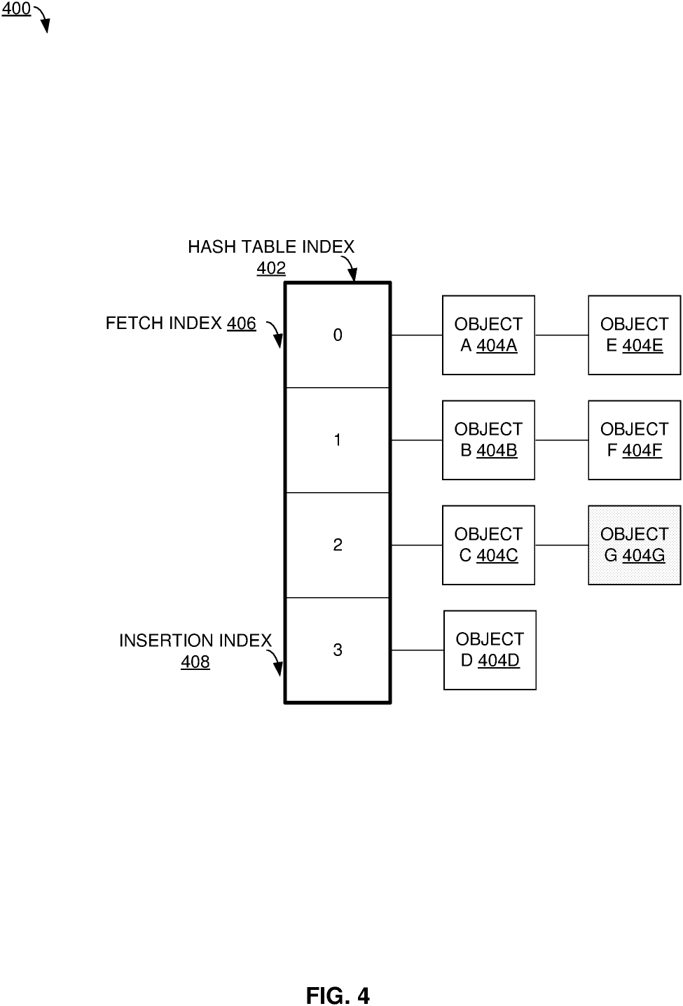

FIG. 4 illustrates an example system architecture 400 for inserting an object into a hash table that can facilitate reducing lock usage for managing nodes in a distributed system, in accordance with an embodiment of this disclosure. In some examples, system architecture 400 can be used to implement reducing lock usage for managing nodes in a distributed system hash table 110 of FIG. 1.

System architecture 400 can generally comprise system architecture 300 of FIG. 3 after an object has been inserted.

System architecture 400 comprises hash table index 402 (which can be similar to hash table index 302), fetch index 406 (which can be similar to fetch index 306), insertion index 408 (which can be similar to insertion index 308), and seven objects stored in a hash table - object A 404A, object B 404B, object C 404C, object D 404D, object E 404E, and object F 404F (which can be similar to object A 304A, object B 304B, object C 304C, object D 304D, object E 304E, and object F 304F, respectively), as well as object G 404G.

Relative to system architecture 300, object G 404G has been inserted at the insertion point indicated by insertion index 308 (index 2). Additionally, insertion index 408 has been correspondingly incremented relative to insertion index 308, and to index 3. Insertions can be performed in this manner, where each insertion is performed and the insertion index is incremented so that insertions are distributed across the buckets of the hash table.

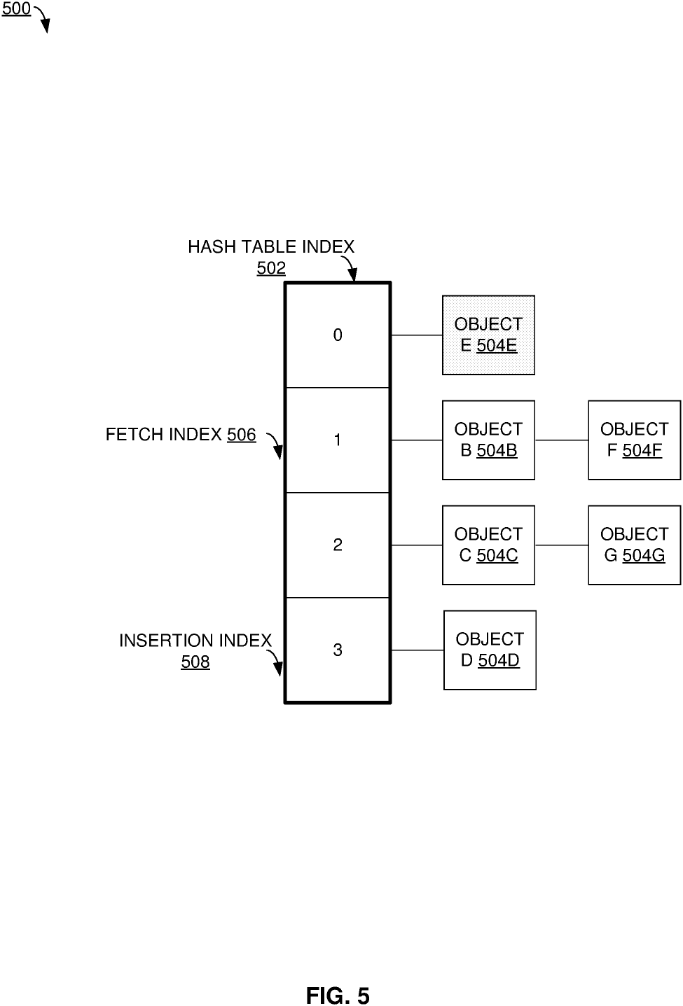

FIG. 5 illustrates an example system architecture 500 for fetching an object from a hash table that can facilitate reducing lock usage for managing nodes in a distributed system, in accordance with an embodiment of this disclosure. In some examples, system architecture 500 can be used to implement reducing lock usage for managing nodes in a distributed system hash table 110 of FIG. 1.

System architecture 500 can generally comprise system architecture 400 of FIG. 4 after an object has been fetched.

System architecture 500 comprises hash table index 502 (which can be similar to hash table index 402), fetch index 506 (which can be similar to fetch index 406), insertion index 508 (which can be similar to insertion index 408), and six objects stored in a hash table - object B 504B, object C 504C, object D 504D, object E 504E, object F 504F, and object G 504G (which can be similar to object B 404B, object C 404C, object D 404D, object E 404E, object F 404F, and object G 404G, respectively).

Relative to system architecture 400, object A 404A has been fetched at the fetch point indicated by fetch index 406 (index 0). Additionally, fetch index 506 has been correspondingly incremented relative to fetch index 406, and to index 1. Fetches can be performed in this manner, where each fetch is performed and the fetch index is incremented so that fetches are distributed across the buckets of the hash table.

Within the bucket at index 0, there were two objects in FIG. 4 – object A 404A and object E 404E. Where each bucket operates as a FIFO queue, and where object A 404A was inserted before object E 404E, it is object A 404A that is selected to be fetched.

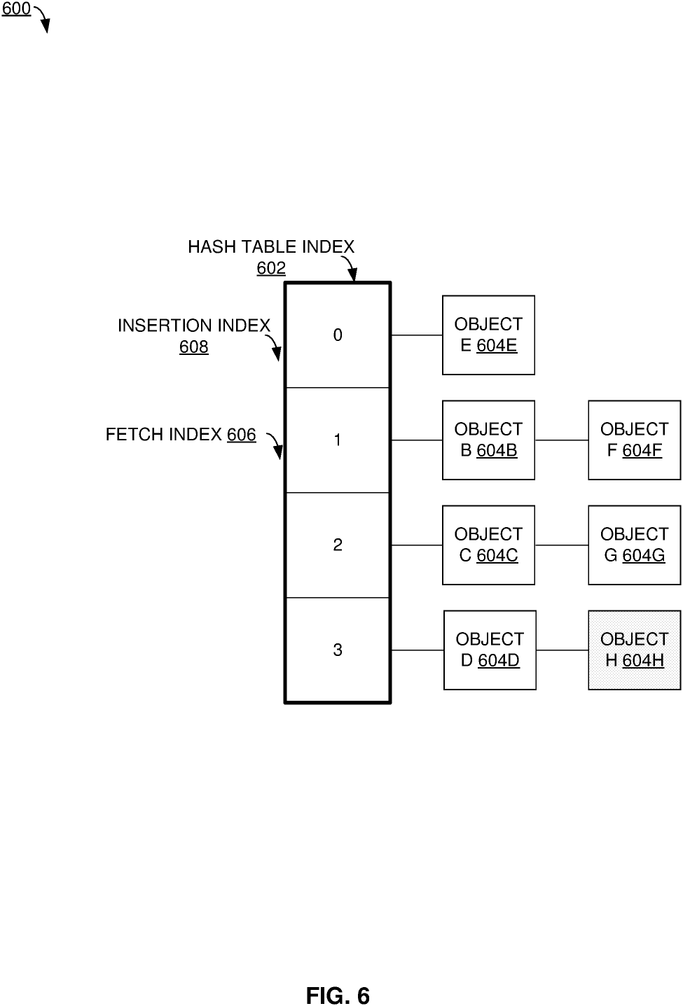

FIG. 6 illustrates an example system architecture 600 for circularly navigating a hash table that can facilitate reducing lock usage for managing nodes in a distributed system, in accordance with an embodiment of this disclosure. In some examples, system architecture 600 can be used to implement reducing lock usage for managing nodes in a distributed system hash table 110 of FIG. 1.

System architecture 600 can generally comprise system architecture 500 of FIG. 5 after an object has been inserted, which causes the insertion index to circle back to index 0 of the hash table index.

System architecture 600 comprises hash table index 602 (which can be similar to hash table index 502), fetch index 606 (which can be similar to fetch index 506), insertion index 608 (which can be similar to insertion index 508), and seven objects stored in a hash table - object B 604B, object C 604C, object D 604D, object E 604E, object F 604F, and object G 604G (which can be similar to object B 504B, object C 504C, object D 504D, object E 504E, and object F 504F, and object G 504G, respectively), as well as object H 604H.

Relative to system architecture 500, object H 604H has been inserted at the insertion point indicated by insertion index 508 (index 3). Additionally, insertion index 608 has been correspondingly incremented relative to insertion index 508, and to index 0.

That is, incrementing the insertion index (and the fetch index) through a hash table index can be performed in a circular manner. When an insertion index points to a largest index of the hash table index (here, index 3), and it is incremented, it can be incremented to point to a smallest index of the hash table index (here, index 0).

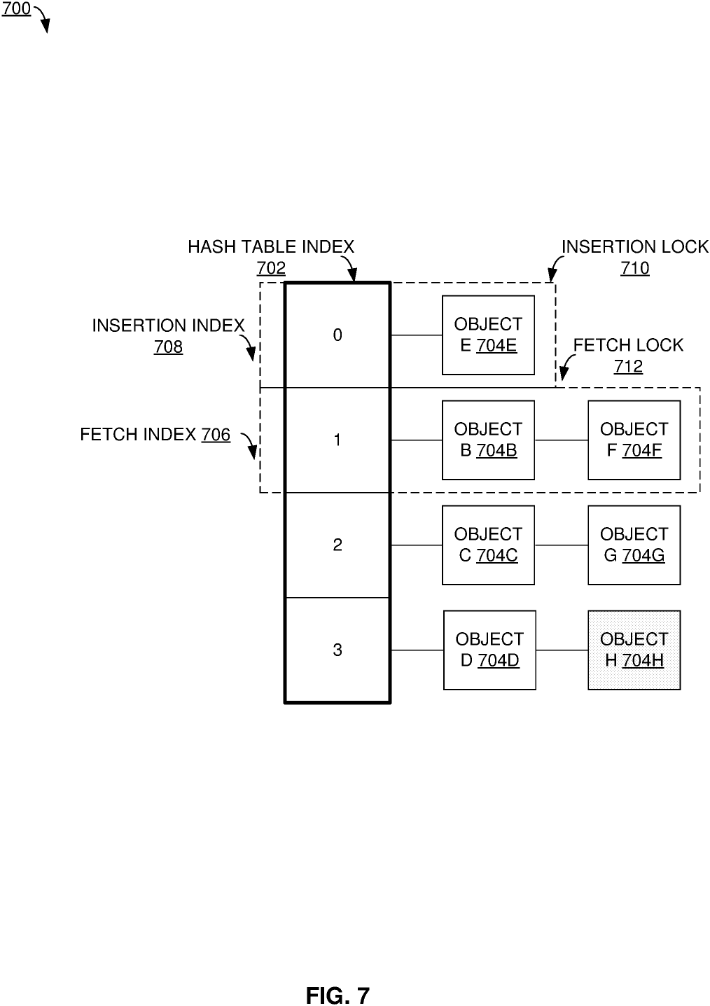

FIG. 7 illustrates an example system architecture 700 for locking individual buckets of a hash table that can facilitate reducing lock usage for managing nodes in a distributed system, in accordance with an embodiment of this disclosure. In some examples, system architecture 700 can be used to implement reducing lock usage for managing nodes in a distributed system hash table 110 of FIG. 1.

System architecture 700 can generally comprise system architecture 600 of FIG. 6 after an object has been inserted, which causes the insertion index to circle back to index 0 of the hash table index.

System architecture 700 comprises hash table index 702 (which can be similar to hash table index 602), fetch index 706 (which can be similar to fetch index 606), insertion index 708 (which can be similar to insertion index 608), and seven objects stored in a hash table - object B 704B, object C 704C, object D 704D, object E 704E, object F 704F, object G 704G, and object H 704H (which can be similar to object B 604B, object C 604C, object D 604D, object E 604E, and object F 604F, object G 604G, and object 604H, respectively).

Relative to system architecture 600, two locks have been taken on two buckets. Insertion lock 710 locks the bucket indicated by index 0 of hash table index 702. Fetch lock 712 locks the bucket indicated by index 1 of hash table index 702. That is, rather than locking the entire hash table to perform an insertion or a fetch, an individual bucket of a hash table can be locked. The entity possessing the lock (e.g., insertion lock 710) can have sole access to read from or write to the locked bucket. By using a lock, insertions and fetches can be performed atomically, where both an insertion and incrementing the insertion index, or both a fetch and incrementing the fetch index, can be performed without another entity getting access to the corresponding bucket while this atomic operation occurs.

### Example Process Flows

FIG. 8 illustrates an example process flow 800 that can facilitate reducing lock usage for managing nodes in a distributed system, in accordance with an embodiment of this disclosure. In some examples, one or more embodiments of process flow 800 can be implemented by reducing lock usage for managing nodes in a distributed system component 108 of FIG. 1, or computing environment 1100 of FIG. 11.

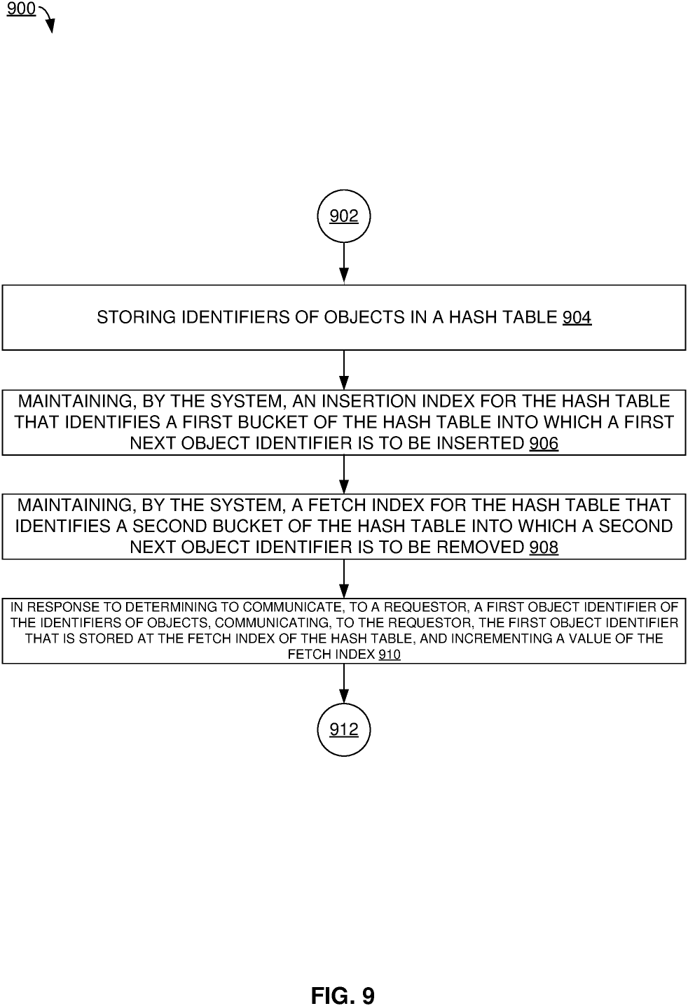

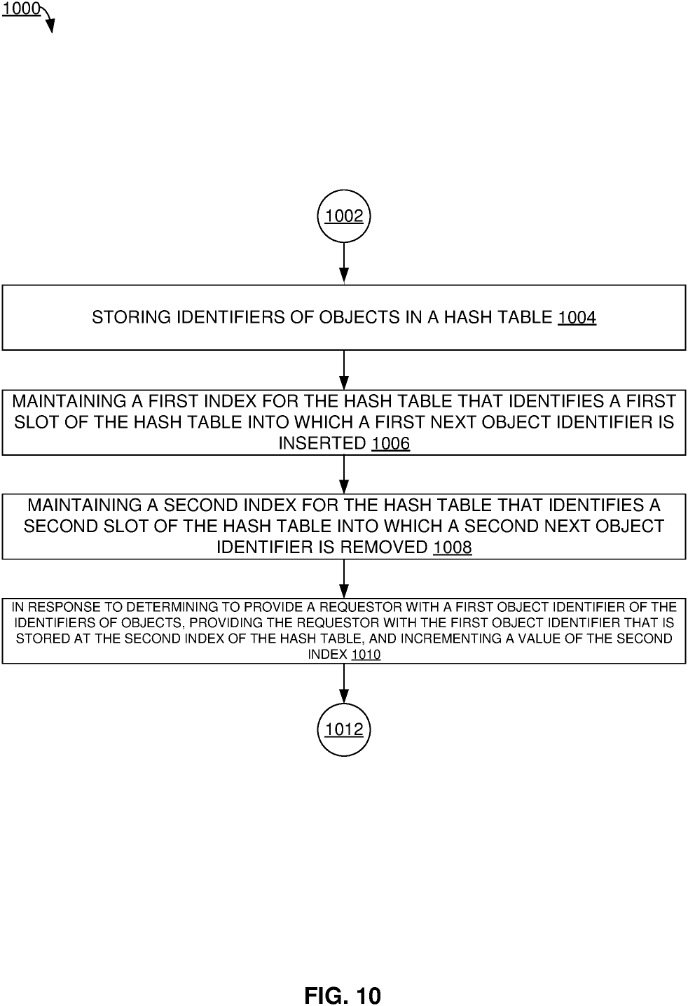

It can be appreciated that the operating procedures of process flow 800 are example operating procedures, and that there can be embodiments that implement more or fewer operating procedures than are depicted, or that implement the depicted operating procedures in a different order than as depicted. In some examples, process flow 800 can be implemented in conjunction with one or more embodiments of one or more of process flow 900 of FIG. 9, and/or process flow 1000 of FIG. 10.

Process flow 800 begins with 802, and moves to operation 804. Operation 804 depicts storing identifiers of devices of a computing cluster in a hash table, wherein worker threads of the computing cluster access the hash table to identify respective devices from which to fetch work. That is, in a cluster, a hash table can be used to provide worker threads with devices from which to fetch useful work. Using the example of FIG. 1, the cluster can be similar to system architecture 100 (where the cluster comprises node A 102A, node B 102B, node C 102C, and node D 102D), the hash table can be reducing lock usage for managing nodes in a distributed system hash table 110, and the worker threads can be worker threads A 112A, worker threads B 112B, worker threads C 112C, and worker threads D 112D. The respective devices can be nodes of the cluster (e.g., node A 102A, node B 102B, node C 102C, and node D 102D).

After operation 804, process flow 800 moves to operation 806.

Operation 806 depicts maintaining an insertion index for the hash table that identifies a first bucket of the hash table into which a first next device identifier is to be inserted. This can be similar to insertion index 208 of FIG. 2.

After operation 806, process flow 800 moves to operation 808.

Operation 808 depicts maintaining a fetch index for the hash table that identifies a second bucket of the hash table into which a second next device identifier is to be removed. This can be similar to fetch index 206 of FIG. 2.

After operation 808, process flow 800 moves to operation 810.

Operation 810 depicts in response to determining to identify a first device identifier of the identifiers of devices to a first worker thread of the worker threads, atomically accessing the first device identifier at the fetch index of the hash table and incrementing the value of the fetch index, and associating the first worker thread with the first device identifier. This can be performed in a similar manner as depicted in FIGS. 4-5. In FIG. 4, fetch index 406 is located at index 0 of hash table index 402. Object A 404A is returned as the first device identifier (where it can serve as an identifier to one of node A 102A, node B 102B, node C 102C, and node D 102D of FIG. 1). Then, after this is performed, in FIG. 5, fetch index 506 has been incremented to index 0 of hash table index 502, and an object that corresponds to object A 404A has been removed from the hash table.

In some examples, incrementing the value of the fetch index comprises updating the value of the fetch index from identifying the second bucket to identifying a third bucket of the hash table. Take the example of FIGS. 4-5. In FIG. 4, fetch index 406 points to index 0 of hash table index 402. Then, in FIG. 5, fetch index 506 has been incremented relative to FIG. 4, and points to index 1 of hash table index 502.

In some examples, the fetch index is monotonically updated. That is, it can be that the fetch index is only incremented and never decremented - the fetch index is moved in only one direction. Monotonically updating the fetch index can comprise performing modulo arithmetic or otherwise rolling the fetch index back to the start of a hash table index when it is incremented past the end of the hash table index. Using the example of FIG. 3, if the fetch index is located at index 3 of hash table index 302 and then is incremented, the fetch index is rolled back to index 0 of hash table index 302.

In some examples, the value of the fetch index is a first value, and operation 810 comprises, in response to determining to make a second device identifier, of the identifiers of devices, available to the worker threads, inserting the second device identifier into the hash table at the insertion index, and incrementing a second value of the insertion index. That is, inserting an object into the hash table can be performed. This can be performed in a similar manner as depicted in FIGS. 3-4. In FIG. 3, insertion index 308 is located at index 2 of hash table index 302. In FIG. 4, object G 404G has been inserted into the hash table at index 2, and the insertion index has been incremented, where insertion index 408 now points to index 2 of the hash table.

In some examples, the value of the fetch index is a first value, and operation 810 comprises performing a fetch-and-add processor instruction at the first index of the hash table. That is, the combination of inserting and incrementing can be performed atomically, where the two steps are performed as one unit, and there is not an intermediary stage (e.g., after inserting but before incrementing) where another process or thread can get access to the insertion index. A fetch-and-add processor instruction can atomically increment contents of a memory location by a set amount. In this manner, an intermediate result of a fetch-and-add processor instruction is unavailable to another actor.

In some examples, operation 810 comprises in response to determining that the first worker thread has completed work for a first device that corresponds to the first device identifier, associating the first worker thread with another device identifier of the identifiers of devices in the hash table other than the first device identifier. That is, once a worker thread completes work for a device, it can fetch a new device from the hash table so that it can perform work issued by that new device.

In some examples, operation 810 comprises, after associating the first worker thread with the first device identifier that is stored at the fetch index of the hash table, removing the first device identifier from the hash table. That is, devices can be removed from a hash table after they are assigned to worker threads. In the example of FIGS. 4-5, object A 404A of FIG. 4 is assigned to a worker thread and then removed from the hash table, so there is no corresponding object in FIG. 5.

After operation 810, process flow 800 moves to 812, where process flow 800 ends.

FIG. 9 illustrates another example process flow 900 that can facilitate reducing lock usage for managing nodes in a distributed system, in accordance with an embodiment of this disclosure. In some examples, one or more embodiments of process flow 900 can be implemented by reducing lock usage for managing nodes in a distributed system component 108 of FIG. 1, or computing environment 1100 of FIG. 11.

It can be appreciated that the operating procedures of process flow 900 are example operating procedures, and that there can be embodiments that implement more or fewer operating procedures than are depicted, or that implement the depicted operating procedures in a different order than as depicted. In some examples, process flow 900 can be implemented in conjunction with one or more embodiments of one or more of process flow 800 of FIG. 8, and/or process flow 1000 of FIG. 10.

Process flow 900 begins with 902, and moves to operation 904. Operation 904 depicts storing identifiers of objects in a hash table. In some examples, operation 904 can be implemented in a similar manner as operation 804 of FIG. 8.

After operation 904, process flow 900 moves to operation 906.

Operation 906 depicts maintaining an insertion index for the hash table that identifies a first bucket of the hash table into which a first next object identifier is to be inserted. In some examples, operation 906 can be implemented in a similar manner as operation 806 of FIG. 8.

After operation 906, process flow 900 moves to operation 908.

Operation 908 depicts maintaining a fetch index for the hash table that identifies a second bucket of the hash table into which a second next object identifier is to be removed. In some examples, operation 908 can be implemented in a similar manner as operation 808 of FIG. 8.

In some examples, the fetch index identifies the first object identifier in response to the first object identifier having been determined to have been inserted into the hash table at an earliest time represented among the identifiers of objects. That is, the hash table can be a FIFO hash table.

In some examples, the first bucket differs from the second bucket. That is, the insertion and fetch points of a hash table can be located at different buckets.

After operation 908, process flow 900 moves to operation 910.

Operation 910 depicts, in response to determining to communicate, to a requestor, a first object identifier of the identifiers of objects, communicating, to the requestor, the first object identifier that is stored at the fetch index of the hash table, and incrementing a value of the fetch index. In some examples, operation 910 can be implemented in a similar manner as operation 810 of FIG. 8.

In some examples, operation 910 comprises refraining from locking the first bucket concurrently with communicating, to the requestor, the first object identifier that is stored at the second bucket. That is, in some examples it is not the entire hash table that is locked when accessing a bucket. Rather, an individual bucket can be locked. In the example of FIG. 7, fetch lock 712 locks the bucket corresponding to index 1 of the hash table, rather than locking the entire hash table.

In some examples, operation 910 comprises locking the second bucket concurrently with communicating, to the requestor, the first object identifier that is stored at the second bucket. That is, accessing a particular bucket of a hash table can involve locking that bucket so that the entity performing the access has exclusive access to the bucket while making the access.

In some examples, the second bucket stores the second next object identifier and a third next object identifier of the identifiers of objects, and communicating, to the requestor, the second next object identifier that is stored at the fetch index comprises determining that the second next object identifier was added to the second bucket prior to the third next object identifier being added to the second bucket. That is, a bucket can store multiple objects and each bucket can serve as its own FIFO queue. For instance, using the example of FIG. 7 and index 1 of the hash table, the next object to be fetched would be object B 704B, followed by object F 704F, followed by whatever object is subsequently inserted into the bucket.

In some examples, the first bucket stores multiple object identifiers of the identifiers of objects, the multiple object identifiers comprise the first object identifier, and operation 910 comprises maintaining an ordering of respective times when respective object identifiers of the multiple object identifiers were inserted into the first bucket. That is, a FIFO queue for each bucket can be handled by inserting objects into a different end of the bucket than fetches are made from.

After operation 910, process flow 900 moves to 912, where process flow 900 ends.

FIG. 10 illustrates another example process flow 1000 that can facilitate reducing lock usage for managing nodes in a distributed system, in accordance with an embodiment of this disclosure. In some examples, one or more embodiments of process flow 1000 can be implemented by reducing lock usage for managing nodes in a distributed system component 108 of FIG. 1, or computing environment 1100 of FIG. 11.

It can be appreciated that the operating procedures of process flow 1000 are example operating procedures, and that there can be embodiments that implement more or fewer operating procedures than are depicted, or that implement the depicted operating procedures in a different order than as depicted. In some examples, process flow 1000 can be implemented in conjunction with one or more embodiments of one or more of process flow 800 of FIG. 8, and/or process flow 900 of FIG. 9.

Process flow 1000 begins with 1002, and moves to operation 1004. Operation 1004 depicts storing identifiers of objects in a hash table. In some examples, operation 1004 can be implemented in a similar manner as operation 804 of FIG. 8.

In some examples, the identifiers of objects identify respective devices of a computing cluster, and the requestor comprises a thread that performs tasks for the devices. That is, process flow 1000 can be implemented on a system architecture similar to that of FIG. 1.

After operation 1004, process flow 1000 moves to operation 1006.

Operation 1006 depicts maintaining a first index for the hash table that identifies a first slot of the hash table into which a first next object identifier is inserted. In some examples, operation 1006 can be implemented in a similar manner as operation 806 of FIG. 8.

After operation 1006, process flow 1000 moves to operation 1008.

Operation 1008 depicts maintaining a second index for the hash table that identifies a second slot of the hash table into which a second next object identifier is removed. In some examples, operation 1008 can be implemented in a similar manner as operation 808 of FIG. 8.

In some examples, the first slot is configured to be accessed with a first lock that is local to the first slot, the second slot is configured to be accessed with a second lock that is local to the second slot, and the first slot is configured to be accessed concurrently with accessing the second slot. That is, buckets of a hash table can be locked individually, similar to as depicted with insertion lock 710 and fetch lock 712 of FIG. 7.

After operation 1008, process flow 1000 moves to operation 1010.

Operation 1010 depicts in response to determining to provide a requestor with a first object identifier of the identifiers of objects, providing the requestor with the first object identifier that is stored at the second index of the hash table, and incrementing a value of the second index. In some examples, operation 1010 can be implemented in a similar manner as operation 810 of FIG. 8.

In some examples, the requestor is a first requestor, and operation 1010 comprises determining to provide a new requestor that comprises the first requestor or the second requestor with a second object identifier of the identifiers of objects; and, in response to determining that the second object identifier is not found in the hash table, performing iterations of, re-determining to provide the new requestor with the second object identifier, and determining whether the second object identifier is found in the hash table. That is, there can be a fetch operation at some point in time after an insert operation. Fetch operations can generally find an object in the hash table. However, in some examples, it can be that a fetch operation does not find an object when it is expected to find one. In such examples, the fetch index can be incremented and subsequent buckets of the hash table can be examined until an object is located, or until each bucket has been examined once. If each bucket is examined once and no object found, the initial condition that prompted the fetch operation can be re-checked, and where valid, the fetch operation can be begun again. Iterations of this can be performed until a fetch operation finds an object in the hash table.

In some examples, operation 1010 comprises waking at least one requestor of a group of requestors that comprises the requestor in response to inserting at least object identifier of the identifiers of objects in the hash table. In some examples, this comprises locking the hash table when waking the at least requestor. That is, when a device is added to the hash table, thread workers can be woken up so that at least one worker is available when inserting devices. In some examples, a lock of the hash table can be taken while performing this operation. This lock can comprise a reader-writer lock, where the threads awaking workers can acquire the lock in read mode. By acquiring the lock in reader mode, multiple threads that awaken workers can proceed in parallel to support high system performance. A thread can be awoken for performance reasons, to reduce latency associated with waiting for a thread to wake without intervention.

After operation 1010, process flow 1000 moves to 1012, where process flow 1000 ends.

### Example Operating Environment

In order to provide additional context for various embodiments described herein, FIG. 11 and the following discussion are intended to provide a brief, general description of a suitable computing environment 1100 in which the various embodiments of the embodiment described herein can be implemented.

For example, parts of computing environment 1100 can be used to implement one or more embodiments of node A 102A, node B 102B, node C 102C, and/or node D 102D of FIG. 1.

In some examples, computing environment 1100 can implement one or more embodiments of the process flows of FIGS. 8-10 to facilitate reducing lock usage for managing nodes in a distributed system.

While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 11, the example environment 1100 for implementing various embodiments described herein includes a computer 1102, the computer 1102 including a processing unit 1104, a system memory 1106 and a system bus 1108. The system bus 1108 couples system components including, but not limited to, the system memory 1106 to the processing unit 1104. The processing unit 1104 can be any of various commercially available processors. Dual microprocessors and other multi-processor architectures can also be employed as the processing unit 1104.

The system bus 1108 can be any of several types of bus structure that can further interconnect to a memory bus (with or without a memory controller), a peripheral bus, and a local bus using any of a variety of commercially available bus architectures. The system memory 1106 includes ROM 1110 and RAM 1112. A basic input/output system (BIOS) can be stored in a nonvolatile storage such as ROM, erasable programmable read only memory (EPROM), EEPROM, which BIOS contains the basic routines that help to transfer information between elements within the computer 1102, such as during startup. The RAM 1112 can also include a high-speed RAM such as static RAM for caching data.

The computer 1102 further includes an internal hard disk drive (HDD) 1114 (e.g., EIDE, SATA), one or more external storage devices 1116 (e.g., a magnetic floppy disk drive (FDD) 1116, a memory stick or flash drive reader, a memory card reader, etc.) and an optical disk drive 1120 (e.g., which can read or write from a CD-ROM disc, a DVD, a BD, etc.). While the internal HDD 1114 is illustrated as located within the computer 1102, the internal HDD 1114 can also be configured for external use in a suitable chassis (not shown). Additionally, while not shown in environment 1100, a solid state drive (SSD) could be used in addition to, or in place of, an HDD 1114. The HDD 1114, external storage device(s) 1116 and optical disk drive 1120 can be connected to the system bus 1108 by an HDD interface 1124, an external storage interface 1126 and an optical drive interface 1128, respectively. The interface 1124 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1102, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1112, including an operating system 1130, one or more application programs 1132, other program modules 1134 and program data 1136. All or portions of the operating system, applications, modules, and/or data can also be cached in the RAM 1112. The systems and methods described herein can be implemented utilizing various commercially available operating systems or combinations of operating systems.

Computer 1102 can optionally comprise emulation technologies. For example, a hypervisor (not shown) or other intermediary can emulate a hardware environment for operating system 1130, and the emulated hardware can optionally be different from the hardware illustrated in FIG. 11. In such an embodiment, operating system 1130 can comprise one virtual machine (VM) of multiple VMs hosted at computer 1102. Furthermore, operating system 1130 can provide runtime environments, such as the Java runtime environment or the .NET framework, for applications 1132. Runtime environments are consistent execution environments that allow applications 1132 to run on any operating system that includes the runtime environment. Similarly, operating system 1130 can support containers, and applications 1132 can be in the form of containers, which are lightweight, standalone, executable packages of software that include, e.g., code, runtime, system tools, system libraries and settings for an application.

Further, computer 1102 can be enable with a security module, such as a trusted processing module (TPM). For instance, with a TPM, boot components hash next in time boot components, and wait for a match of results to secured values, before loading a next boot component. This process can take place at any layer in the code execution stack of computer 1102, e.g., applied at the application execution level or at the operating system (OS) kernel level, thereby enabling security at any level of code execution.

A user can enter commands and information into the computer 1102 through one or more wired/wireless input devices, e.g., a keyboard 1138, a touch screen 1140, and a pointing device, such as a mouse 1142. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1104 through an input device interface 1144 that can be coupled to the system bus 1108, but can be connected by other interfaces, such as a parallel port, an IEEE 1394 serial port, a game port, a USB port, an IR interface, a BLUETOOTH® interface, etc.

A monitor 1146 or other type of display device can be also connected to the system bus 1108 via an interface, such as a video adapter 1148. In addition to the monitor 1146, a computer typically includes other peripheral output devices (not shown), such as speakers, printers, etc.

The computer 1102 can operate in a networked environment using logical connections via wired and/or wireless communications to one or more remote computers, such as a remote computer(s) 1150. The remote computer(s) 1150 can be a workstation, a server computer, a router, a personal computer, portable computer, microprocessor-based entertainment appliance, a peer device or other common network node, and typically includes many or all of the elements described relative to the computer 1102, although, for purposes of brevity, only a memory/storage device 1152 is illustrated. The logical connections depicted include wired/wireless connectivity to a local area network (LAN) 1154 and/or larger networks, e.g., a wide area network (WAN) 1156. Such LAN and WAN networking environments are commonplace in offices and companies, and facilitate enterprise-wide computer networks, such as intranets, all of which can connect to a global communications network, e.g., the Internet.

When used in a LAN networking environment, the computer 1102 can be connected to the local network 1154 through a wired and/or wireless communication network interface or adapter 1158. The adapter 1158 can facilitate wired or wireless communication to the LAN 1154, which can also include a wireless access point (AP) disposed thereon for communicating with the adapter 1158 in a wireless mode.

When used in a WAN networking environment, the computer 1102 can include a modem 1160 or can be connected to a communications server on the WAN 1156 via other means for establishing communications over the WAN 1156, such as by way of the Internet. The modem 1160, which can be internal or external and a wired or wireless device, can be connected to the system bus 1108 via the input device interface 1144. In a networked environment, program modules depicted relative to the computer 1102 or portions thereof, can be stored in the remote memory/storage device 1152. It will be appreciated that the network connections shown are example and other means of establishing a communications link between the computers can be used.

When used in either a LAN or WAN networking environment, the computer 1102 can access cloud storage systems or other network-based storage systems in addition to, or in place of, external storage devices 1116 as described above. Generally, a connection between the computer 1102 and a cloud storage system can be established over a LAN 1154 or WAN 1156 e.g., by the adapter 1158 or modem 1160, respectively. Upon connecting the computer 1102 to an associated cloud storage system, the external storage interface 1126 can, with the aid of the adapter 1158 and/or modem 1160, manage storage provided by the cloud storage system as it would other types of external storage. For instance, the external storage interface 1126 can be configured to provide access to cloud storage sources as if those sources were physically connected to the computer 1102.

The computer 1102 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

### Conclusion

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory in a single machine or multiple machines. Additionally, a processor can refer to an integrated circuit, a state machine, an application specific integrated circuit (ASIC), a digital signal processor (DSP), a programmable gate array (PGA) including a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units. One or more processors can be utilized in supporting a virtualized computing environment. The virtualized computing environment may support one or more virtual machines representing computers, servers, or other computing devices. In such virtualized virtual machines, components such as processors and storage devices may be virtualized or logically represented. For instance, when a processor executes instructions to perform “operations”, this could include the processor performing the operations directly and/or facilitating, directing, or cooperating with another device or component to perform the operations.

In the subject specification, terms such as “datastore,” data storage,” “database,” “cache,” and substantially any other information storage component relevant to operation and functionality of a component, refer to “memory components,” or entities embodied in a “memory” or components comprising the memory. It will be appreciated that the memory components, or computer-readable storage media, described herein can be either volatile memory or nonvolatile storage, or can include both volatile and nonvolatile storage. By way of illustration, and not limitation, nonvolatile storage can include ROM, programmable ROM (PROM), EPROM, EEPROM, or flash memory. Volatile memory can include RAM, which acts as external cache memory. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

The illustrated embodiments of the disclosure can be practiced in distributed computing environments where certain tasks are performed by remote processing devices that are linked through a communications network. In a distributed computing environment, program modules can be located in both local and remote memory storage devices.

The systems and processes described above can be embodied within hardware, such as a single integrated circuit (IC) chip, multiple ICs, an ASIC, or the like. Further, the order in which some or all of the process blocks appear in each process should not be deemed limiting. Rather, it should be understood that some of the process blocks can be executed in a variety of orders that are not all of which may be explicitly illustrated herein.

As used in this application, the terms “component,” “module,” “system,” “interface,” “cluster,” “server,” “node,” or the like are generally intended to refer to a computer-related entity, either hardware, a combination of hardware and software, software, or software in execution or an entity related to an operational machine with one or more specific functionalities. For example, a component can be, but is not limited to being, a process running on a processor, a processor, an object, an executable, a thread of execution, computer-executable instruction(s), a program, and/or a computer. By way of illustration, both an application running on a controller and the controller can be a component. One or more components may reside within a process and/or thread of execution and a component may be localized on one computer and/or distributed between two or more computers. As another example, an interface can include input/output (I/O) components as well as associated processor, application, and/or application programming interface (API) components.

Further, the various embodiments can be implemented as a method, apparatus, or article of manufacture using standard programming and/or engineering techniques to produce software, firmware, hardware, or any combination thereof to control a computer to implement one or more embodiments of the disclosed subject matter. An article of manufacture can encompass a computer program accessible from any computer-readable device or computer-readable storage/communications media. For example, computer readable storage media can include but are not limited to magnetic storage devices (e.g., hard disk, floppy disk, magnetic strips...), optical discs (e.g., CD, DVD...), smart cards, and flash memory devices (e.g., card, stick, key drive...). Of course, those skilled in the art will recognize many modifications can be made to this configuration without departing from the scope or spirit of the various embodiments.

In addition, the word “example” or “exemplary” is used herein to mean serving as an example, instance, or illustration. Any embodiment or design described herein as “exemplary” is not necessarily to be construed as preferred or advantageous over other embodiments or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

What has been described above includes examples of the present specification. It is, of course, not possible to describe every conceivable combination of components or methods for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
a processor; and
a memory that stores executable instructions that, when executed by the processor, facilitate performance of operations, comprising:
storing identifiers of devices of a computing cluster in a hash table, wherein worker threads of the computing cluster access the hash table to identify respective devices from which to fetch work;
maintaining an insertion index for the hash table that identifies a first bucket of the hash table into which a first next device identifier is to be inserted;
maintaining a fetch index for the hash table that identifies a second bucket of the hash table into which a second next device identifier is to be removed; and
in response to determining to identify a first device identifier of the identifiers of devices to a first worker thread of the worker threads, atomically accessing the first device identifier at the fetch index of the hash table and incrementing the value of the fetch index, and associating the first worker thread with the first device identifier.

2. The system of claim 1, wherein the value of the fetch index is a first value, and wherein the operations further comprise:
in response to determining to make a second device identifier, of the identifiers of devices, available to the worker threads, inserting the second device identifier into the hash table at the insertion index, and incrementing a second value of the insertion index.

3. The system of claim 1, wherein atomically accessing the first device identifier at the fetch index of the hash table and incrementing the value of the fetch index comprises:
performing a fetch-and-add processor instruction at the first index of the hash table.

4. The system of claim 1, wherein incrementing the value of the fetch index comprises:
updating the value of the fetch index from identifying the second bucket to identifying a third bucket of the hash table.

5. The system of claim 1, wherein the fetch index is monotonically updated.

6. The system of claim 1, wherein the operations further comprise:
in response to determining that the first worker thread has completed work for a first device that corresponds to the first device identifier, associating the first worker thread with another device identifier of the identifiers of devices in the hash table other than the first device identifier.

7. The system of claim 1, wherein the operations further comprise:
after associating the first worker thread with the first device identifier that is stored at the fetch index of the hash table, removing the first device identifier from the hash table.

8. A method, comprising:
storing, by a system comprising a processor, identifiers of objects in a hash table;
maintaining, by the system, an insertion index for the hash table that identifies a first bucket of the hash table into which a first next object identifier is to be inserted;
maintaining, by the system, a fetch index for the hash table that identifies a second bucket of the hash table into which a second next object identifier is to be removed; and
in response to determining to communicate, to a requestor, a first object identifier of the identifiers of objects, communicating, by the system to the requestor, the first object identifier that is stored at the fetch index of the hash table, and incrementing a value of the fetch index.

9. The method of claim 8, wherein the fetch index identifies the first object identifier in response to the first object identifier having been determined to have been inserted into the hash table at an earliest time represented among the identifiers of objects.

10. The method of claim 8, further comprising:
refraining, by the system, from locking the first bucket concurrently with communicating, to the requestor, the first object identifier that is stored at the second bucket.

11. The method of claim 8, further comprising:
locking, by the system, the second bucket concurrently with communicating, to the requestor, the first object identifier that is stored at the second bucket.

12. The method of claim 8, wherein the second bucket stores the second next object identifier and a third next object identifier of the identifiers of objects, and wherein communicating, to the requestor, the second next object identifier that is stored at the fetch index comprises determining that the second next object identifier was added to the second bucket prior to the third next object identifier being added to the second bucket.

13. The method of claim 8, wherein the first bucket stores multiple object identifiers of the identifiers of objects, wherein the multiple object identifiers comprise the first object identifier, and further comprising:
maintaining, by the system, an ordering of respective times when respective object identifiers of the multiple object identifiers were inserted into the first bucket.

14. The method of claim 8, wherein the first bucket differs from the second bucket.

15. A non-transitory computer-readable medium comprising instructions that, in response to execution, cause a system comprising a processor to perform operations, comprising:
storing identifiers of objects in a hash table;
maintaining a first index for the hash table that identifies a first slot of the hash table into which a first next object identifier is inserted;
maintaining a second index for the hash table that identifies a second slot of the hash table into which a second next object identifier is removed; and
in response to determining to provide a requestor with a first object identifier of the identifiers of objects, providing the requestor with the first object identifier that is stored at the second index of the hash table, and incrementing a value of the second index.

16. The non-transitory computer-readable medium of claim 15, wherein the requestor is a first requestor, and wherein the operations further comprise:
determining to provide a new requestor that comprises the first requestor or the second requestor with a second object identifier of the identifiers of objects;
and, in response to determining that the second object identifier is not found in the hash table, performing iterations of,
re-determining to provide the new requestor with the second object identifier, and
determining whether the second object identifier is found in the hash table.

17. The non-transitory computer-readable medium of claim 15, wherein the operations further comprise:
waking at least one requestor of a group of requestors that comprises the requestor in response to inserting at least object identifier of the identifiers of objects in the hash table.

18. The non-transitory computer-readable medium of claim 17, wherein the operations further comprise:
locking the hash table when waking the at least requestor.

19. The non-transitory computer-readable medium of claim 15, wherein the identifiers of objects identify respective devices of a computing cluster, and wherein the requestor comprises a thread that performs tasks for the devices.

20. The non-transitory computer-readable medium of claim 15, wherein the first slot is configured to be accessed with a first lock that is local to the first slot, wherein the second slot is configured to be accessed with a second lock that is local to the second slot, and wherein the first slot is configured to be accessed concurrently with accessing the second slot.
